(19) United States
(12) Patent Application Publication
(10) Pub. No.: US 2018/0329421 A1
(43) Pub. Date: Nov. 15, 2018

(54) ROAD LINK INFORMATION UPDATING DEVICE AND VEHICLE CONTROL SYSTEM

(71) Applicant: TOYOTA JIDOSHA KABUSHIKI KAISHA, Toyota-shi (JP)

(72) Inventors: Toshiki KINDO, Yokohama-shi (JP); Ryo IGARASHI, Susono-shi (JP); Junichi MEGURO, Nagakute-shi (JP); Kunihiro GOTO, Nagakute-shi (JP)

(73) Assignee: TOYOTA JIDOSHA KABUSHIKI KAISHA, Toyota-shi (JP)

(21) Appl. No.: 15/978,561

(22) Filed: May 14, 2018

(30) Foreign Application Priority Data
May 15, 2017 (JP) 2017-096547

(51) Int. Cl. G05D 1/02; G08G 1/052; G08G 1/048

(52) U.S. Cl. CPC G05D 1/0223; G08G 1/052; G05D 2201/0213; G05D 1/0276; G08G 1/048

(57) ABSTRACT

Provided is a road link information updating device including an information acquisition unit configured to acquire speed information on a plurality of communication target vehicles in association with positions of the communication target vehicles, a road link information database configured to store road link information on a plurality of nodes and a road link connecting the nodes to each other, an inflection point position recognition unit configured to recognize an inflection point position in the road link from a change in the vehicle speed or the acceleration, a road link information updating unit configured to update the road link information by using the inflection point position as the node, and a recommended speed setting unit configured to set a recommended speed to the node, on the basis of the speed information and the road link information.

### CROSS-REFERENCE TO RELATED APPLICATION

This application is based on Japanese Patent Application No.2017-096547 filed with Japan Patent Office on May 15, 2017, the entire contents of which are hereby incorporated by reference.

### TECHNICAL FIELD

The present invention relates to a road link information updating device and a vehicle control system.

### BACKGROUND

In recent years, Japanese Unexamined Patent Publication No. 2015-097071 is known as the related art regarding information generation using data acquired by a probe car. A safety speed information generation device disclosed in the official bulletin calculates an average traveling speed of the probe car in a road link from traveling speed related data acquired by the probe car, and sets a median of the distribution of the average traveling speeds as a safety speed in the road link.

### SUMMARY

Incidentally, each road link in the above-described device is sectioned with, for example, a junction or a crossroads as a node (nodal point). However, in a case where a lane width is reduced in the road link due to a guardrail which is partially provided, or the like, a speed appropriate for a vehicle changes before and behind the reduction in the lane width. For this reason, as in the device of the related art, it may not be appropriate to set one speed for each road link determined in advance.

Consequently, in the technical field, it is desired that a road link information updating device capable of appropriately setting a recommended speed by updating road link information with an inflection point position in the road line, which is recognized from changes in a vehicle speed or an acceleration of a communication target vehicle such as a probe car, as a new node and a vehicle control system using the road link information updating device are provided.

In order to solve the above-described problem, a road link information updating device according to an aspect of the invention includes an information acquisition unit configured to acquire speed information on vehicle speeds or accelerations of a plurality of communication target vehicles in association with positions of the communication target vehicles by communicating with the communication target vehicles, a road link information database configured to store road link information on a plurality of nodes including a junction and a road link connecting the nodes to each other, an inflection point position recognition unit configured to recognize an inflection point position in the road link from a change in the vehicle speed or the acceleration, on the basis of the speed information and the road link information, a road link information updating unit configured to update the road link information by using the inflection point position as the node, and a recommended speed setting unit configured to set a recommended speed in the node, on the basis of the speed information and the road link information.

According to the road link information updating device of the aspect of the invention, it is possible to update road link information by using the inflection point position in the road link recognized from changes in a vehicle speed or an acceleration of the communication target vehicle as a new node. Thereby, in the road link information updating device, it is possible to add a node which is useful for the setting of a recommended speed from a viewpoint of traveling of the communication target vehicle rather than from information, such as a junction, on the map. Therefore, in the road link information updating device, it is possible to set a recommended speed in the node according to the actual condition of the communication target vehicle that travels.

In the road link information updating device according to the aspect of the invention, the information acquisition unit may acquire external environment information on the communication target vehicle and recognize the speed information for each classification of the external environment which is set in advance, by communicating with the communication target vehicle, and the recommended speed setting unit may set the recommended speed in the node for each classification of the external environment, on the basis of the speed information which is recognized for each classification of the external environment.

According to the road link information updating device, it is considered that the vehicle speed of the communication target vehicle fluctuates due to an external environment such as the density of vehicles in the vicinity of the communication target vehicle even in the same node, and thus it is possible to appropriately set a recommended speed in consideration of classification of the external environment.

A vehicle control system according to another aspect of the invention includes a recommended speed acquisition unit configured to acquire recommended speed information on a recommended speed of a node which is set in the above-described road link information updating device, a vehicle position recognition unit configured to recognize a position of the vehicle on a map, an external environment recognition unit configured to recognize an external environment of the vehicle, a traveling state recognition unit configured to recognize a traveling state of the vehicle, a driving plan generation unit configured to generate a driving plan of the vehicle, on the basis of the recommended speed information, the position of the vehicle on the map, the external environment of the vehicle, and a traveling state of the vehicle, and a vehicle control unit configured to control traveling of the vehicle in accordance with the driving plan.

According to the vehicle control system, the driving plan can be generated in consideration of the recommended speed which is set in the node by the road link information updating device, and thus it is possible to appropriately reflect the recommended speed which is set in the node for the control of traveling of the vehicle.

A vehicle control system according to still another aspect of the invention includes a recommended speed acquisition unit configured to acquire recommended speed information on a recommended speed of a node for each classification of an external environment which is set in the above-described road link information updating device, a vehicle position recognition unit configured to recognize a position of the vehicle on a map, an external environment recognition unit configured to recognize an external environment of the vehicle and classification of the external environment of the vehicle from the external environment of the vehicle, a traveling state recognition unit configured to recognize a traveling state of the vehicle, a driving plan generation unit configured to generate a driving plan of the vehicle, on the basis of the recommended speed information, the position of the vehicle on the map, the external environment of the vehicle, and the traveling state of the vehicle, and a vehicle control unit configured to control traveling of the vehicle in accordance with the driving plan, in which the driving plan generation unit generates the driving plan by using the recommended speed based on the classification of the external environment of the vehicle in the road link based on the position of the vehicle on the map. According to the vehicle control system, the driving plan of the vehicle can be generated so as to set a recommended speed based on the classification of the external environment of the vehicle by using the recommended speed which is set in the node for each classification of the external environment by the road link information updating device, and thus it is possible to reflect an appropriate recommended speed based on the classification of the external environment of the vehicle on the control of traveling of the vehicle.

As described above, according to a road link information updating device according to an aspect of the invention, it is possible to appropriately set a recommended speed by updating road link information with an inflection point position in the road link, which is recognized from changes in a vehicle speed or an acceleration of a communication target vehicle, as a new node.

### BRIEF DESCRIPTION OF THE DRAWINGS

FIG. 1 is a block diagram of a road link information updating device according to a first embodiment.

FIG. 2 is a diagram illustrating a center having the road link information updating device, and a communication target vehicle.

FIG. 3 is a diagram illustrating a the communication target vehicle travels. (A) of FIG. 3 is a plan view illustrating a road on which the communication target vehicle travels; (B) of FIG. 3 is a graph illustrating changes in a vehicle speed of the communication target vehicle corresponding to a position on the road; (C) of FIG. 3 is a graph illustrating changes in an acceleration of the communication target vehicle corresponding to a position on the road; and (D) of FIG. 3 is a histogram illustrating a frequency of an inflection point corresponding to a position on the road.

FIG. 4 is a flow chart illustrating processing of the road link information updating device according to the first embodiment.

FIG. 5 is a block diagram of a road link information updating device according to a second embodiment.

FIG. 6A is a graph illustrating a relationship between a vehicle speed of a communication target vehicle and an inter-vehicle distance between the communication target vehicle and a preceding vehicle; and FIG. 6B is a graph illustrating a relationship between the density of vehicles in the vicinity of the communication target vehicle and a vehicle speed of the communication target vehicle.

FIG. 7 is a flow chart illustrating processing of the road link information updating device according to the second embodiment.

FIG. 8 is a block diagram of a vehicle control system according to a third embodiment.

FIG. 9 is a flow chart illustrating processing of a vehicle control system according to a third embodiment.

FIG. 10 is a block diagram of a vehicle control system according to a fourth embodiment.

FIG. 11 is a flow chart illustrating processing of the vehicle control system according to the fourth embodiment.

### DETAILED DESCRIPTION

Hereinafter, embodiments of the invention will be described with reference to the accompanying drawings.

### First Embodiment

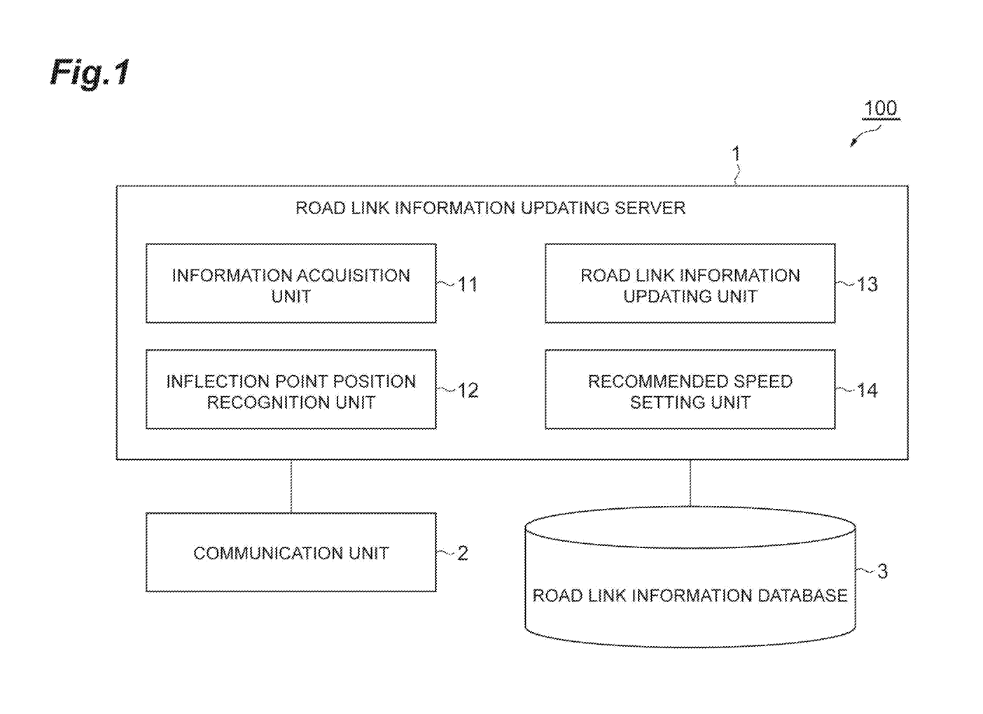

FIG. 1 is a block diagram of a road link information updating device according to a first embodiment. A road link information updating device 100 according to the first embodiment illustrated of FIG. 1 is provided, for example, in a center (institution) that manages traffic information, and collects various data of a communication target vehicle through communication with the communication target vehicle.

As an example, the communication target vehicle is a vehicle (probe car) for information collection which has a function of communicating with the road link information updating device 100. The communication target vehicle has a function of detecting a position on its own map and its own vehicle speed. The communication target vehicle may include a general vehicle having a function of communicating with the road link information updating device 100. The road link information updating device 100 updates road link information on the basis of collected data of the communication target vehicle. The updating of the road link information will be described later in detail.

### Configuration of Road Link Information Updating Device According to First Embodiment

As illustrated of FIG. 1, the road link information updating device 100 includes a road link information updating server 1. The road link information updating server 1 is configured as a general computer including a Central Processing Unit (CPU), a storage unit, a communication control unit, and the like. The storage unit may be a memory within the road link information updating server 1 accessible by the CPU, or may be a storage medium such as a Hard Disk Drive (HDD). The storage unit may be provided outside the road link information updating server 1. The communication control unit is a communication device, such as a network card, which controls communication. The road link information updating server 1 may be constituted by a plurality of computers, or may be a cloud server.

The road link information updating server 1 is connected to a communication unit 2 and a road link information database 3. The communication unit 2 is a wireless communication equipment for communicating with the communication target vehicle. The communication unit 2 can be configured as a communication equipment of a center in which the road link information updating server 1 is provided.

The road link information database 3 is a database that stores road link information. The road link information is information on road links and nodes which are set on the map. The road link means a road section between the nodes. The node is a point at which the road links are connected to each other (or a point at which the road links are separated from each other). The node includes one or more junctions. A standard road link serves as a road section from a certain junction to the subsequent junction. The road link information database 3 may constitute a portion of the road link information updating server 1, or may be provided in an institution different from the road link information updating server 1.

Next, a functional configuration of the road link information updating server 1 will be described. The road link information updating server 1 includes an information acquisition unit 11, an inflection point position recognition unit 12, a road link information updating unit 13, and a recommended speed setting unit 14.

The information acquisition unit 11 communicates with the communication target vehicle through the communication unit 2 to acquire speed information on the communication target vehicle. The information acquisition unit 11 acquires speed information in association with the position (position on the map) of the communication target vehicle. The speed information includes information on the position of the communication target vehicle and information on a vehicle speed and an acceleration on the communication target vehicle at the position. Meanwhile, the speed information may include only one of the vehicle and the acceleration, and the other may be obtained by computational operation as necessary. The speed information acquired by the information acquisition unit 11 is stored in the road link information database 3 or a storage unit of the road link information updating server 1.

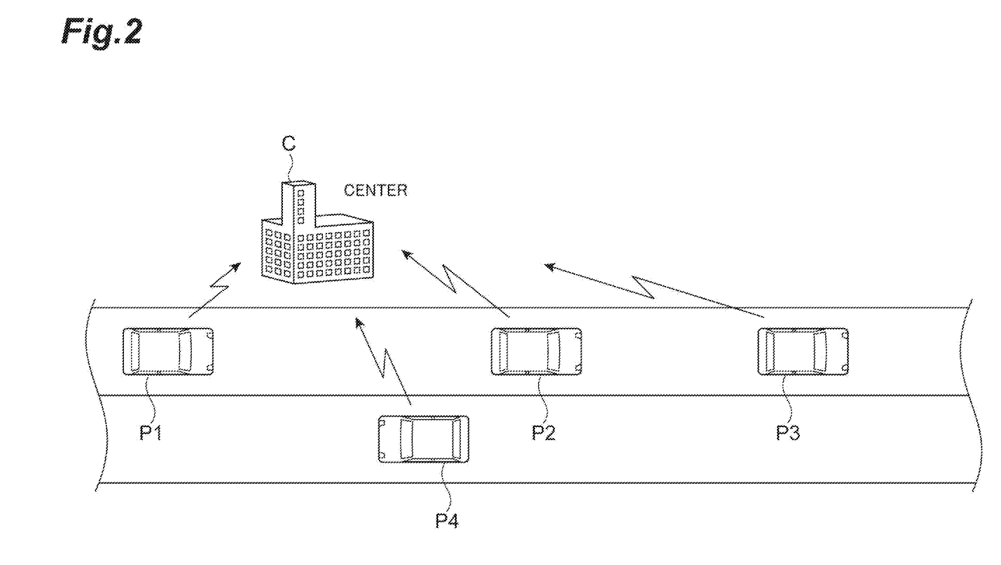

FIG. 2 is a diagram illustrating a center having the road link information updating device, and a communication target vehicle. FIG. 2 illustrates a center C in which the road link information updating server 1 is provided, and communication target vehicles P1 to P4. The information acquisition unit 11 acquires speed information from each of the communication target vehicles P1 to P4.

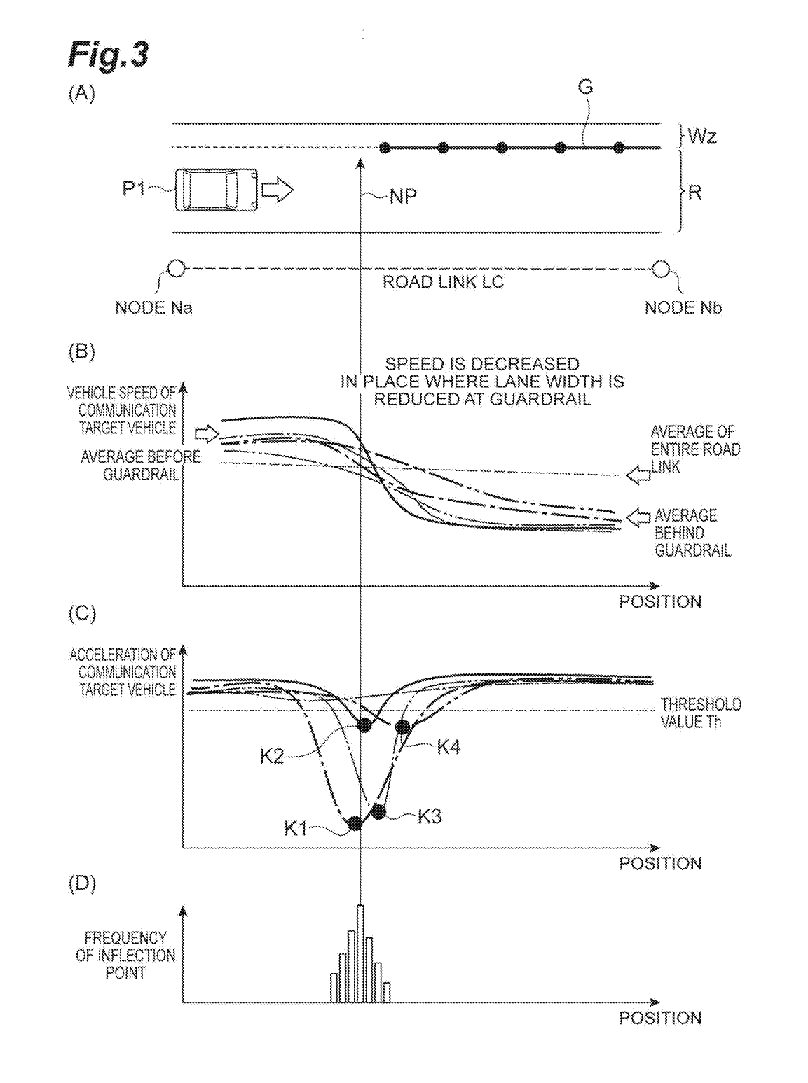

(A) of FIG. 3 is a plan view illustrating a road on which a communication target vehicle travels. (A) of FIG. 3 illustrates a road (vehicle passing zone) R on which the communication target vehicle P1 travels, a walking zone W adjacent to the road R, and a guardrail G provided between the road R and the walking zone W. (A) of FIG. 3 illustrates a node Na, a node Nb, and a road link LC which is a road section between the node Na and the node Nb. In conditions illustrated in (A) of FIG. 3, the guardrail G is partially provided from the middle of the road link LC, and thus the width of the road R on which the communication target vehicle P1 travels is reduced in the road link LC. An arrow (NP) in (A) of FIG. 3 will be described later.

(B) of FIG. 3 is a graph illustrating changes in a vehicle speed of the communication target vehicle corresponding to a position on the road. The vertical axis in (B) of FIG. 3 represents a vehicle speed of the communication target vehicle, and the horizontal axis represents a position in an extending direction of the road R. In (B) of FIG. 3, averages of the vehicle speed of the communication target vehicle before and behind the guardrail are indicated by arrows. In addition, an average of the entire road link of the vehicle speed of the communication target vehicle is indicated by a dashed line. As illustrated in (B) of FIG. 3, the communication target vehicle traveling on the road R has a vehicle speed behind the guardrail G (after the width of the road is reduced) which is reduced as compared to the vehicle speed just before the guardrail G (before the width of the road is reduced). Such a graph in (B) of FIG. 3 can be obtained from speed information on a plurality of communication target vehicles which are acquired by the information acquisition unit 11.

The inflection point position recognition unit 12 recognizes an inflection point position in the road link (between nodes) from changes in a vehicle speed or an acceleration of the communication target vehicle on the basis of the speed information on the communication target vehicle which is acquired by the information acquisition unit 11 and the road link information stored in the road link information database 3. The inflection point position is a position at which the vehicle speed of the communication target vehicle remarkably changes.

Here, (C) of FIG. 3 is a graph illustrating changes in an acceleration of the communication target vehicle corresponding to a position on the road. The vertical axis in (C) of FIG. 3 represents an acceleration of the communication target vehicle, and the horizontal axis represents the position in an extending direction of the road R. (C) of FIG. 3 illustrates inflection points K1 to K4 of changes in acceleration of each communication target vehicle and a threshold value Th. In conditions illustrated in (C) of FIG. 3, the inflection points K1 to K4 of the acceleration are set to be minimum values of the acceleration of each communication target vehicle in the road link LC.

The inflection point position recognition unit 12 recognizes the inflection points K1 to K4 of acceleration of the communication target vehicle for each road link from the speed information of the communication target vehicle which is acquired by the information acquisition unit 11. The inflection point position recognition unit 12 secures the accuracy of recognition, and thus recognizes only the inflection points K1 to K4 changing in excess of the threshold value Th from the average of the acceleration in the entire road link. The threshold value Th is a threshold value of a value which is set in advance. Meanwhile, an inflection point is not necessarily recognized for each road link. In addition, the threshold value Th is not necessarily used.

(D) of FIG. 3 is a histogram illustrating a frequency of an inflection point corresponding to positions on the road. The vertical axis in (D) of FIG. 3 represents a frequency of an inflection point, and the horizontal axis represents a position in an extending direction of the road R. In the histogram in (D) of FIG. 3, for example, the road R is divided into sections (for example, sections at intervals of 0.25 m) at fixed distances along the extending direction of the road R, and the number of inflection points included in each of the sections are indicated by a frequency of the inflection point. Here, strictly speaking, (D) of FIG. 3 does not correspond to the inflection point in (C) of FIG. 3, and the histogram is illustrated as an image.

As an example, the inflection point position recognition unit 12 recognizes a center position of a section in which the frequency of an inflection point is set to be the maximum (peak) in the histogram of (D) of FIG. 3, as an inflection point position NP. FIGS. (A) to (D) illustrate an arrow corresponding to the inflection point position NP. As illustrated of FIGS. (A) to (D), the inflection point position NP corresponds to a position where the communication target vehicle changes its vehicle speed due to a reduction in the width of the road R based on the guardrail G.

Meanwhile, the inflection point position recognition unit 12 does not necessarily recognize the inflection point position NP by using the above-described method. The inflection point position recognition unit 12 may recognize an average position of all of the inflection points as the inflection point position NP, or may recognize the inflection point position NP from the position of an inflection point by using a predetermined computational expression.

The road link information updating unit 13 performs the updating of road link information by using the inflection point position NP recognized by the inflection point position recognition unit 12 as a new node. The road link information updating unit 13 divides the road link LC in (A) of FIG. 3 into two road links by using the inflection point position NP as a new node to update road link information so as to include the new node and the separate road links. The road link information updating unit 13 stores the updated road link information in the road link information database 3.

The recommended speed setting unit 14 sets a recommended speed in the node included in the road link information, on the basis of the speed information of the communication target vehicle which is acquired by the information acquisition unit 11. The recommended speed setting unit 14 also sets a recommended speed for a node which is newly added by the road link information updating unit 13. For example, in a case where a fixed amount of speed information on the node are collected, the recommended speed setting unit 14 sets an average value of vehicle speeds which is the plurality of pieces of speed information as a recommended speed of the node. Meanwhile, the recommended speed is not necessarily an average value of a plurality of vehicle speeds, and may be a median of a plurality of vehicle speeds. The recommended speed may be a computational value which is obtained from the plurality of pieces of speed information by a predetermined computational expression.

The recommended speed which is set by the recommended speed setting unit 14 is stored in the road link information database 3 in association with the node. Meanwhile, the recommended speed may be stored in a database different from the road link information database 3.

### Processing of Road Link Information Updating Device According to First Embodiment

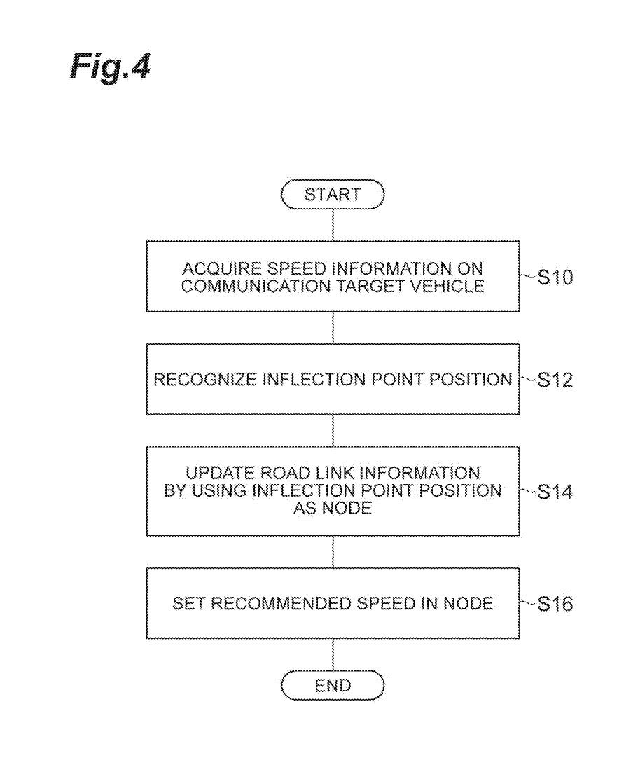

Next, processing of the road link information updating device 100 according to the first embodiment will be described with reference to FIG. 4. FIG. 4 is a flow chart illustrating processing of the road link information updating device 100 according to the first embodiment.

As illustrated of FIG. 4, the road link information updating server 1 of the road link information updating device 100 performs the acquisition of speed information on a communication target vehicle by the information acquisition unit 11, as S10. The information acquisition unit 11 communicates with the communication target vehicle through the communication unit 2 to acquire the speed information on the communication target vehicle.

As S12, the road link information updating server 1 recognizes an inflection point position in the road link by the inflection point position recognition unit 12. The inflection point position recognition unit 12 recognizes the inflection point position NP in the road link from changes in a vehicle speed or an acceleration of the communication target vehicle on the basis of speed information and road link information of the communication target vehicle.

As S14, the road link information updating server 1 performs the updating of the road link information by the road link information updating unit 13 by using the inflection point position NP as a new node. The road link information updating unit 13 divides the road link into two road links by using the inflection point position NP as a new node to update the road link information to include the new node and the separate road links.

As S16, the road link information updating server 1 sets a recommended speed in the node included in the road link information by the recommended speed setting unit 14. For example, the recommended speed setting unit 14 sets an average of the vehicle speed of the communication target vehicle in the node as a recommended speed of the node.

### Operational Effects of Road Link Information Updating Device According to First Embodiment

According to the above-described road link information updating device 100 of the first embodiment, it is possible to update road link information by using an inflection point position in the road link recognized from changes in a vehicle speed or an acceleration of a communication target vehicle as a new node. Thereby, in the road link information updating device 100, it is possible to add a node which is useful for the setting of a recommended speed from a viewpoint of traveling of the communication target vehicle rather than from information, such as a junction, on the map. Therefore, in the road link information updating device 100, it is possible to set a recommended speed in the node according to the actual condition of the communication target vehicle that travels.

### Second Embodiment

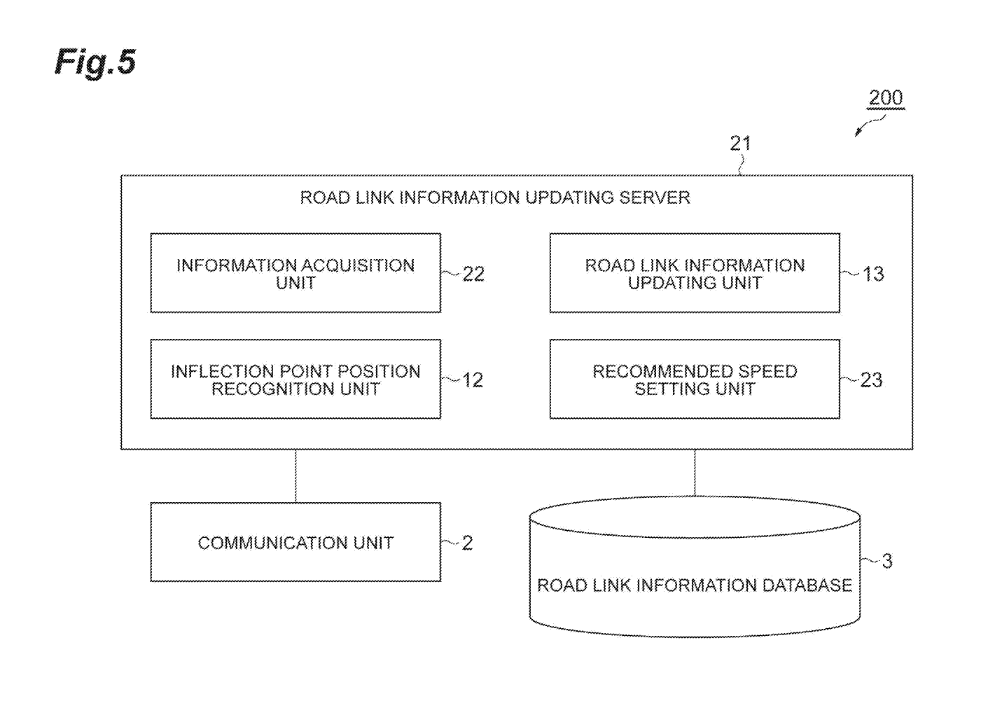

FIG. 5 is a block diagram of a road link information updating device according to a second embodiment. A road link information updating device 200 according to the second embodiment illustrated of FIG. 5 is different from the road link information updating device according to the first embodiment in that an external environment (dynamic environment) of a communication target vehicle is also considered. The same or equivalent components as those in the first embodiment will be denoted by the same reference numerals and signs, and a repeated description will be omitted.

### Configuration of Road Link Information Updating Device According to Second Embodiment

In the road link information updating device 200, an information acquisition unit 22 of a road link information updating server 21 communicates with a communication target vehicle through a communication unit 2 to acquire external environment information on the communication target vehicle and acquire speed information on the communication target vehicle. The information acquisition unit 22 acquires the external environment information and the speed information on the communication target vehicle in association with each other. The information acquisition unit 22 recognizes an external environment of the communication target vehicle when the communication target vehicle detects speed information on the basis of the external environment information and the speed information.

The external environment recognized by the information acquisition unit 22 includes at least one of an inter-vehicle distance between the communication target vehicle and a preceding vehicle, the density of vehicles in the vicinity of the communication target vehicle, the density of pedestrians in the vicinity of the communication target vehicle, speeds of other vehicles in the vicinity of the communication target vehicle, and a time factor (day and night, or the like).

The inter-vehicle distance between the communication target vehicle and the preceding vehicle is an inter-vehicle distance between the communication target vehicle and the previous preceding vehicle that travels ahead of the communication target vehicle on the same lane as the communication target vehicle. In a case where there is no preceding vehicle (for example, in a case where a preceding vehicle is not detected by a sensor of the communication target vehicle), the inter-vehicle distance between the communication target vehicle and the preceding vehicle may be set to be a fixed value which is set in advance.

The density of vehicles in the vicinity of the communication target vehicle represents, for example, the number of other vehicles within a fixed range based on the communication target vehicle. The fixed range refers to, for example, a range of a fixed distance from the communication target vehicle. The fixed range does not include a facing lane, and may be a range of a fixed distance from the communication target vehicle on the vehicle passing zone in which the communication target vehicle travels.

The density of pedestrians in the vicinity of the communication target vehicle represents, for example, the number of pedestrians within a fixed range based on the communication target vehicle. The pedestrian may include a bicycle. The speed of other vehicles in the vicinity of the communication target vehicle represents, for example, vehicle speeds of other vehicles within a fixed range based on the communication target vehicle. In a case where a plurality of other vehicles are present within the fixed range, the speed is set to be an average value of vehicle speeds of the plurality of other vehicles. The time factor is, for example, distinction between day and night. The time factor may include distinction between morning, daytime, evening, and night.

The information acquisition unit 22 recognizes speed information for each classification of a preset external environment. As classifications of the external environment, for example, two classifications of “short inter-vehicle distance” and “long inter-vehicle distance” can be adopted with respect to the inter-vehicle distance between the communication target vehicle and the preceding vehicle.

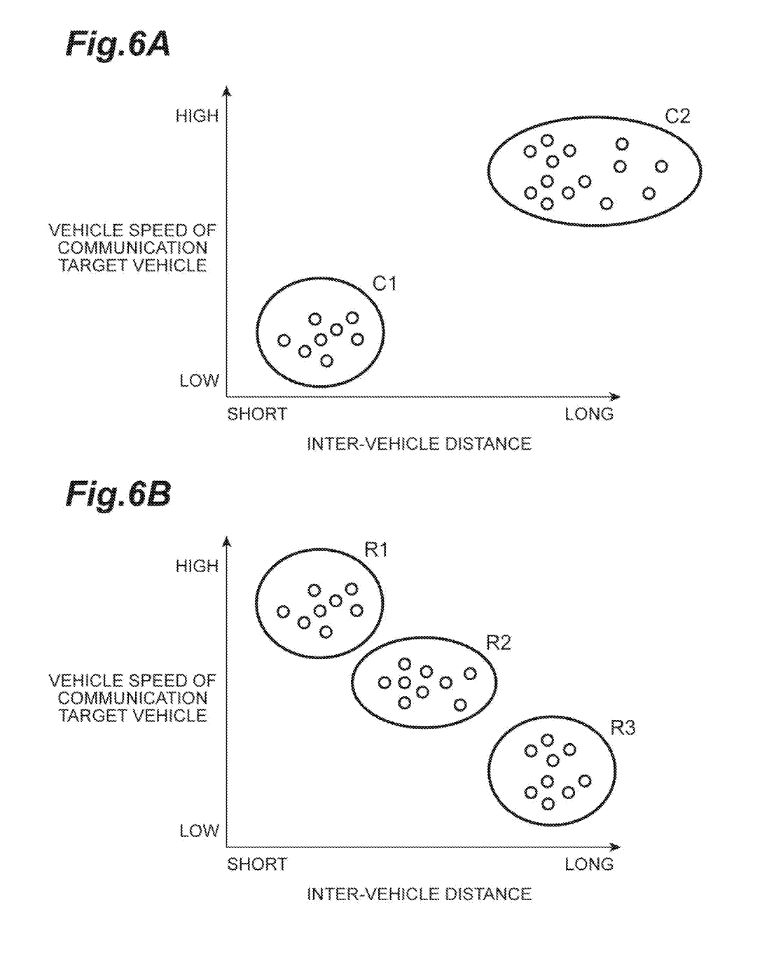

Here, FIG. 6A is a graph illustrating a relationship between a vehicle speed of a communication target vehicle and an inter-vehicle distance between the communication target vehicle and a preceding vehicle. The horizontal axis of FIG. 6A represents an inter-vehicle distance between the communication target vehicle and the preceding vehicle, and the vertical axis represents a vehicle speed of the communication target vehicle. In FIG. 6A, an intersection point between the vehicle speed of the communication target vehicle and the inter-vehicle distance between the communication target vehicle and the preceding vehicle in one node is shown as a white circle. The white circle corresponds to speed information of the communication target vehicle associated with an external environment. In addition, white circles close to each other will be collectively referred to as a cluster C1 and a cluster C2. The cluster C1 is a group in which the inter-vehicle distance between the communication target vehicle and the preceding vehicle is long. The cluster C2 is a group in which the inter-vehicle distance between the communication target vehicle and the preceding vehicle is short. In the cluster C2, the vehicle speed of the communication target vehicle is lower than that in the cluster C1.

As illustrated of FIG. 6A, when the inter-vehicle distance between the communication target vehicle and the preceding vehicle varies even in the same node, the vehicle speed of the communication target vehicle varies. For this reason, in the road link information updating device 200, a recommended speed appropriate for the node is set for each classification of an external environment by considering the external environment when the communication target vehicle detects speed information.

Specifically, the information acquisition unit 22 recognizes the classification of the external environment from external environment information of the communication target vehicle to distinctively recognize speed information for each classification of the external environment. For example, in a case where the inter-vehicle distance between the communication target vehicle and the preceding vehicle is less than an inter-vehicle distance threshold value, the information acquisition unit 22 recognizes the speed information on the communication target vehicle as speed information of the classification of “short inter-vehicle distance”. The inter-vehicle distance threshold value is a threshold value which is set in advance. The information acquisition unit 22 recognizes speed information included in cluster C1 of FIG. 6A as speed information of the classification of “short inter-vehicle distance”.

For example, in a case where the inter-vehicle distance between the communication target vehicle and the preceding vehicle is equal to or greater than the inter-vehicle distance threshold value, the information acquisition unit 22 recognizes speed information on the communication target vehicle as speed information of the classification of “long inter-vehicle distance”. The information acquisition unit 22 recognizes speed information included in the cluster C2 as speed information of the classification of “long inter-vehicle distance”. The information acquisition unit 22 may classify the inter-vehicle distance into three or more classifications.

FIG. 6B is a graph illustrating a relationship between the density of vehicles in the vicinity of the communication target vehicle and a vehicle speed of the communication target vehicle. The horizontal axis of FIG. 6B represents the density of vehicles in the vicinity of the communication target vehicle, and the vertical axis represents the vehicle speed of the communication target vehicle. In FIG. 6B, an intersection point between the density of vehicles in the vicinity of the communication target vehicle in one node and the vehicle speed of the communication target vehicle is shown as a white circle.

In FIG. 6B, white circles close to each other will be collectively referred to as a cluster R1, a cluster R2, and a cluster R3. The cluster R1 is a group in which the density of vehicles is low. The cluster R3 is a group in which the density of vehicles is highest. The cluster R2 is a group between the cluster R1 and the cluster R3. The vehicle speed of the communication target vehicle is decreased in order of the cluster R1, the cluster R2, and the cluster R3. In FIG. 6B, the vehicle speed of the communication target vehicle varies in accordance with the density of vehicles as an external environment.

For example, in a case where the density of vehicles is less than a first vehicle density threshold value, the information acquisition unit 22 recognizes speed information on the communication target vehicle as speed information of classification of “low vehicle density”. The first vehicle density threshold value is a threshold value which is set in advance. The information acquisition unit 22 recognizes speed information included in the cluster R1 of FIG. 6B as speed information of the classification of “low vehicle density”.

For example, in a case where the density of vehicles is equal to or greater than the first vehicle density threshold value and is less than a second vehicle density threshold value, the information acquisition unit 22 recognizes the speed information on the communication target vehicle as speed information of classification of “middle vehicle density”. The second vehicle density threshold value is a threshold value which is larger than the first vehicle density threshold value. The information acquisition unit 22 recognizes speed information included in the cluster R2 as speed information of the classification of “middle vehicle density”.

Similarly, for example, in a case where the density of vehicles is equal to or greater than the second vehicle density threshold value, the information acquisition unit 22 recognizes the speed information on the communication target vehicle as speed information of classification of “high vehicle density”. In FIG. 6B, the information acquisition unit 22 recognizes speed information included in the cluster R3 as speed information of the classification of “high vehicle density”. The information acquisition unit 22 may classify the density of vehicles into two classifications, or may classify the density of vehicles into four or more classifications.

The information acquisition unit 22 can similarly classify the density of pedestrians in the vicinity of the communication target vehicle and the speed of other vehicles in the vicinity of the communication target vehicle as external environments into a plurality of classifications by using a threshold value and the like. The information acquisition unit 22 may classify a time factor as an external environment into classification of day and classification of night, or may classify the time factor into three or more classifications by using a threshold value. The information acquisition unit 22 distinctively recognizes speed information on the communication target vehicle for each classification of an external environment.

The information acquisition unit 22 may combine classifications of a plurality of external environments with each other to minutely distinguish speed information on the communication target vehicle. For example, the information acquisition unit 22 may distinctively recognize speed information (speed information in a case of congestion) of the communication target vehicle of classification of “short inter-vehicle distance” and “high vehicle density” and speed information (speed information when the surrounding lanes are congested, but the front of the communication target vehicle is empty) of the communication target vehicle of classification of “long inter-vehicle distance” and “high vehicle density”. The information acquisition unit 22 can adopt a combination of various classifications. The information acquisition unit 22 stores the recognized speed information for each classification of the external environment in the road link information database 3. Meanwhile, the information acquisition unit 22 may store the speed information for each classification of the external environment in a database different from the road link information database 3.

An inflection point position recognition unit 12 and a road link information updating unit 13 perform the same processing as that in the first embodiment. The inflection point position recognition unit 12 recognizes an inflection point position from speed information on the communication target vehicle regardless of classification of an external environment. The road link information updating unit 13 updates road link information by using an inflection point position NP recognized by the inflection point position recognition unit 12 as a new node.

A recommended speed setting unit 23 sets a recommended speed in a node for each classification of an external environment, on the basis of the speed information recognized for each classification of the external environment by the information acquisition unit 22. Specifically, the recommended speed setting unit 23 can set an average value of vehicle speeds which is pieces of speed information included in the cluster C1 ( ) in a case of “short inter-vehicle distance” in the node, as a recommended speed of the node in a case where the classification of the external environment is “short inter-vehicle distance” in conditions illustrated of FIG. 6A.

Similarly, the recommended speed setting unit 23 may set an average value of vehicle speeds which is pieces of speed information included in the cluster R3 in a case of “high vehicle density” in the node, as a recommended speed of the node in a case where the classification of the external environment is “high vehicle density” in conditions illustrated of FIG. 6B.

In a case where the information acquisition unit 22 combines classifications of a plurality of external environments to distinguish speed information on the communication target vehicle, the recommended speed setting unit 23 may set a recommended speed in the node for each combination of the classifications of the plurality of external environments. Specifically, the recommended speed setting unit 23 may set an average value of vehicle speeds which is a plurality of pieces of speed information included in classification of “short inter-vehicle distance” and “high vehicle density” in the node, as a recommended speed of the node in a case where the classification of the external environment is “short inter-vehicle distance” and “high vehicle density”.

Similarly, the recommended speed setting unit 23 may set an average value of vehicle speeds which is a plurality of pieces of speed information included in classification of “long inter-vehicle distance” and “high vehicle density” in the node, as a recommended speed of the node in a case where the classification of the external environment is “long inter-vehicle distance” and “high vehicle density”. Meanwhile, the recommended speed may not be necessarily an average value of a plurality of vehicle speeds, and may be a median of a plurality of vehicle speeds. The recommended speed may be a computational value which is obtained from a plurality of pieces of speed information by a predetermined computational expression.

### Processing of Road Link Information Updating Device According to Second Embodiment

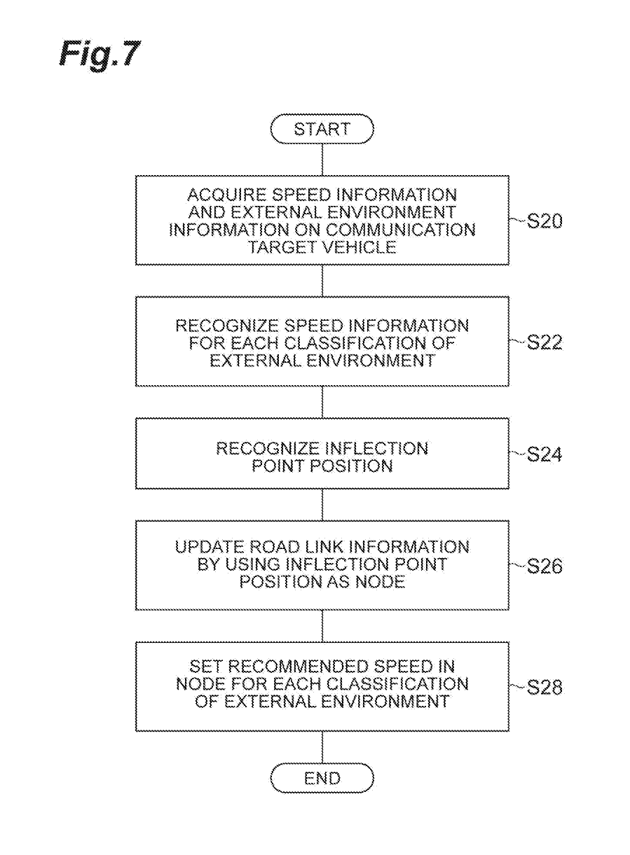

Next, processing of the road link information updating device 200 according to the second embodiment will be described with reference to FIG. 7. FIG. 7 is a flow chart illustrating processing of the road link information updating device 200 according to the second embodiment.

As illustrated of FIG. 7, the road link information updating server 21 of the road link information updating device 200 performs the acquisition of speed information and external environment information on a communication target vehicle by the information acquisition unit 22, as S20. The information acquisition unit 22 communicates with the communication target vehicle through the communication unit 2 to acquire the speed information and the external environment information. The information acquisition unit 22 acquires the speed information and the external environment information in association with each other.

As S22, the road link information updating server 21 recognizes speed information for each classification of an external environment by the information acquisition unit 22. The information acquisition unit 22 recognizes the classification of the external environment from the external environment information on the communication target vehicle to distinctively recognize the speed information for each classification of the external environment.

As S24, the road link information updating server 21 recognizes an inflection point position in the road link by the inflection point position recognition unit 12. Here, S24 is the same as the process of S12 in the flow chart of FIG. 4.

As S26, the road link information updating server 21 performs the updating of road link information by using the inflection point position NP recognized by the road link information updating unit 13 as a new node. Here, S26 is the same as the process of S14 in the flow chart of FIG. 4.

As S28, the road link information updating server 21 sets a recommended speed in a node for each classification of an external environment by the recommended speed setting unit 23. The recommended speed setting unit 23 sets an average value of vehicle speeds of a plurality of pieces of speed information recognized by the node in the classification of the same external environment, as a recommended speed of the node in the classification of the external environment.

### Operational Effects of Road Link Information Updating Device According to Second Embodiment

According to the above-described road link information updating device 200 of the second embodiment, it is considered that the vehicle speed of the communication target vehicle fluctuates due to an external environment such as the density of vehicles in the vicinity of the communication target vehicle even in the same node, and thus it is possible to appropriately set a recommended speed by considering classification of the external environment.

### Third Embodiment

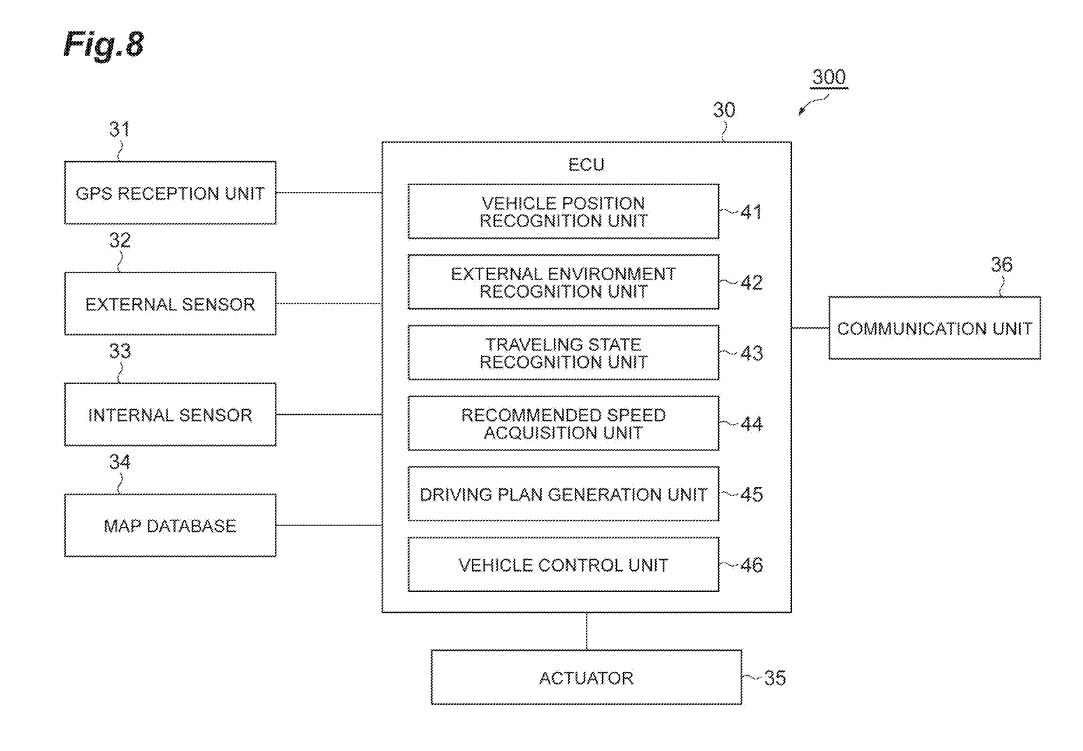

FIG. 8 is a block diagram of a vehicle control system according to a third embodiment. A vehicle control system 300 illustrated of FIG. 8 is mounted on a vehicle such as a motor car, and controls the traveling of the vehicle. For example, the vehicle control system 300 is an automatic driving system that executes automatic driving control. The automatic driving control refers to vehicle control for causing the vehicle to automatically travel toward a destination which is set in advance. The vehicle control system 300 does not necessarily need to execute the automatic driving control, and may execute driving support control for controlling the traveling of the vehicle by mainly a driver's driving operation. The vehicle control system 300 uses the recommended speed, which is set by the road link information updating device 100 according to the first embodiment, for the control of traveling of the vehicle.

### Configuration of Vehicle Control System According to Third Embodiment

As illustrated of FIG. 8, the vehicle control system 300 includes an Electronic Control Unit (ECU) 10 that generally manages the system. The ECU 30 is an electronic control unit including a Central Processing Unit (CPU), a Read Only Memory (ROM), a Random Access Memory (RAM), a Controller Area Network (CAN) communication circuit, and the like. For example, the ECU 30 executes various functions by loading programs stored in the ROM into the RAM and executing the programs loaded into the RAM by the CPU. The ECU 30 may be constituted by a plurality of electronic units.

The ECU 30 is connected to a GPS reception unit 31, an external sensor 32, an internal sensor 33, a map database 34, an actuator 35, and a communication unit 36.

The GPS reception unit 31 receives signals from three or more GPS satellites to measure the position of a vehicle (for example, the latitude and longitude of the vehicle). The GPS reception unit 31 transmits the measured positional information of the vehicle to the ECU 30.

The external sensor 32 is a detection apparatus that detects conditions in the vicinity of the vehicle. The external sensor 32 includes at least one of a camera and a radar sensor.

The camera is an imaging apparatus that images external conditions of the vehicle. The camera is provided at the back of a windshield of the vehicle. The camera transmits imaging information on the external conditions of the vehicle to the ECU 30. The camera may be a monocular camera or may be a stereo camera. The stereo camera includes two imaging units that are disposed so as to reproduce binocular parallax. Imaging information of the stereo camera also includes information in a depth direction.

The radar sensor is a detection apparatus that detects an obstacle in the vicinity of the vehicle by using radio waves (for example, millimeter waves) or light. The radar sensor includes, for example, a millimeter wave radar or Light Detection And Ranging (LIDAR). The radar sensor transmits the radio waves or the light to the vicinity of the vehicle and receives the radio waves or the light reflected from the obstacle to detect the obstacle. The radar sensor transmits the detected obstacle information to the ECU 30. The obstacle includes a moving obstacle such as a pedestrian, a bicycle, or another vehicle, in addition to a fixed obstacle such as a guardrail or a building.

The internal sensor 33 is a detection apparatus that detects a traveling state of the vehicle. The internal sensor 33 includes a vehicle speed sensor, an acceleration sensor, and a yaw rate sensor. The vehicle speed sensor is a detector that detects the speed of the vehicle. An example of the vehicle speed sensor to be used is a wheel speed sensor which is provided with respect to a wheel of the vehicle or a drive shaft or the like rotating integrally with the wheel of the vehicle, and detects the rotation speed of the wheel. The vehicle speed sensor transmits the detected vehicle speed information (wheel speed information) to the ECU 30.

The acceleration sensor is a detector that detects the acceleration of the vehicle. The acceleration sensor includes, for example, a front-back acceleration sensor that detects the acceleration of the vehicle in a front-back direction, and a horizontal acceleration sensor that detects the horizontal acceleration of the vehicle. The acceleration sensor transmits, for example, the acceleration information on the vehicle to the ECU 30. The yaw rate sensor is a detector that detects a yaw rate (rotation angle speed) around the vertical axis of the center of gravity of the vehicle. As the yaw rate sensor, for example, a gyro sensor can be used. The yaw rate sensor transmits the detected yaw rate information on the vehicle to the ECU 30.

The map database 34 is a database that stores map information. For example, the map database 34 is formed within a Hard Disk Drive (HDD) mounted on the vehicle. The map information includes positional information on a road, information on the shape of the road (for example, a curve, a type of linear portion, a curvature of the curve, or the like), positional information on a junction and a crossroads, positional information on a structure, and the like. Meanwhile, the map database 34 may be formed in a computer of an institution such as a management center capable of communicating with the vehicle.

The actuator 35 is an apparatus which is used for the control of the vehicle. The actuator 35 includes at least a throttle actuator, a brake actuator, and a steering actuator. The throttle actuator controls the amount of air (throttle opening) to be supplied to an engine in accordance with a control signal from the ECU 30, and controls a driving force of the vehicle. Meanwhile, in a case where the vehicle is a hybrid car, the driving force is controlled by the input of a control signal from the ECU 30 to a motor as a power source, in addition to the amount of air to be supplied to the engine. In a case where the vehicle is an electric car, the driving force is controlled by the input of a control signal from the ECU 30 to a motor (motor function as an engine) as a power source. The motor as a power source in these cases constitutes the actuator 35 instead of the throttle actuator.

The brake actuator controls a brake system in accordance with a control signal from the ECU 30, and controls a braking force to be applied to the wheel of the vehicle. As the brake system, for example, a hydraulic brake system can be used. The steering actuator controls the driving of an assist motor for controlling a steering torque in an electric power steering system, in accordance with a control signal from the ECU 30. Thereby, the steering actuator controls a steering torque of the vehicle.

The communication unit 36 is a device for acquiring various information through a wireless network (the Internet or the like). The communication unit 36 communicates with the road link information updating server 1 according to the first embodiment.

Next, a functional configuration of the ECU 30 will be described. The ECU 30 includes a vehicle position recognition unit 41, an external environment recognition unit 42, a traveling state recognition unit 43, a recommended speed acquisition unit 44, a driving plan generation unit 45, and a vehicle control unit 46.

The vehicle position recognition unit 41 recognizes the position of the vehicle on the map on the basis of positional information on the GPS reception unit 31 and map information on the map database 34. In addition, the vehicle position recognition unit 41 recognizes the position of the vehicle by a Simultaneous Localization and Mapping (SLAM) technique by using positional information on a fixed obstacle, such as an electric pole included in the map information on the map database 34, and a detection result of the external sensor 32. In addition, the vehicle position recognition unit 41 may recognize the position of the vehicle on the map by a known method.

The external environment recognition unit 42 recognizes an external environment of the vehicle on the basis of a detection result of the external sensor 32. The external environment recognition unit 42 recognizes the external environment of the vehicle by a known method on the basis of a captured image of the camera and obstacle information of the radar sensor.

The traveling state recognition unit 43 recognizes the state of the vehicle during traveling, on the basis of a detection result of the internal sensor 33. The traveling state includes a vehicle speed of the vehicle, an acceleration of the vehicle, and a yaw rate of the vehicle. Specifically, the traveling state recognition unit 43 recognizes the vehicle speed of the vehicle on the basis of vehicle speed information of the vehicle speed sensor. The traveling state recognition unit 43 recognizes the acceleration (front-back acceleration and horizontal acceleration) of the vehicle on the basis of acceleration information of the acceleration sensor. The traveling state recognition unit 43 recognizes the yaw rate of the vehicle on the basis of yaw rate information of the yaw rate sensor.

The recommended speed acquisition unit 44 communicates with the road link information updating device 100 through the communication unit 36 to acquire recommended speed information regarding a recommended speed which is set in a node by the road link information updating device 100. The recommended speed information includes positional information on the node and information on the recommended speed which is set in the node.

The recommended speed acquisition unit 44 acquires recommended speed information regarding a recommended speed of a node in the vicinity of the vehicle, on the basis of the position of the vehicle on the map which is recognized by the vehicle position recognition unit 41. The recommended speed acquisition unit 44 may acquire recommended speed information on a node on a route toward a destination from the present position of the vehicle. The destination may be set by a crew of the vehicle which includes a driver, or may be automatically set by the vehicle control system 300 using a known technique. In addition, the number of routes may be two or more.

The driving plan generation unit 45 generates a driving plan for the control of the vehicle, on the basis of a destination which is set in advance, the map information of the map database 34, the position of the vehicle on the map which is recognized by the vehicle position recognition unit 41, the external environment of the vehicle which is recognized by the external environment recognition unit 42, the traveling state of the vehicle which is recognized by the traveling state recognition unit 43, and the recommended speed information acquired by the recommended speed acquisition unit 44.

The driving plan includes a steering plan regarding the steering of the vehicle and a vehicle speed plan regarding a vehicle speed of the vehicle. The steering plan includes a target steering angle based on the position of the vehicle traveling on a route. The position on the route is a position in an extending direction of a route (that is, a target route of the vehicle) on the map. Specifically, the position on the route can be a setting vertical position which is set for each predetermined interval (for example, 1 m) in the extending direction of the route. The target steering angle is a value which is a target for the control of a steering angle of the vehicle in the driving plan. The driving plan generation unit 45 sets the target steering angle for each of positions separated from each other at predetermined intervals on the route to generate a steering plan. Meanwhile, a target steering torque or a target horizontal position (position in a width direction of a target road of the vehicle) may be used instead of the target steering angle.

The vehicle speed plan includes a target vehicle speed based on the position of the vehicle traveling on the route. The target vehicle speed is a value which is a target for the control of a vehicle speed of the vehicle in a driving plan. The driving plan generation unit 45 sets the target vehicle speed for each of positions separated from each other at predetermined intervals on the route to generate a vehicle speed plan. The driving plan generation unit 45 generates the vehicle speed plan such that a vehicle speed of the vehicle passing through a node is set to be a recommended speed which is set in the node, on the basis of the recommended speed of the node which is acquired by the recommended speed acquisition unit 44. Meanwhile, a target acceleration or a target jerk may be used instead of the target vehicle speed. The target vehicle speed may be based on a time instead of the position on the route (setting vertical position).

The vehicle control unit 46 controls the traveling of the vehicle on the basis of the map information of the map database 34, the position of the vehicle on the map which is recognized by the vehicle position recognition unit 41, the external environment of the vehicle which is recognized by the external environment recognition unit 42, the traveling state of the vehicle which is recognized by the traveling state recognition unit 43, and the driving plan generated by the driving plan generation unit 45. The vehicle control unit 46 transmits a control signal to the actuator 35 to execute the control of the vehicle based on the driving plan. The control of the vehicle may be automatic driving control or may be driving support control.

### Processing of Vehicle Control System According to Third Embodiment

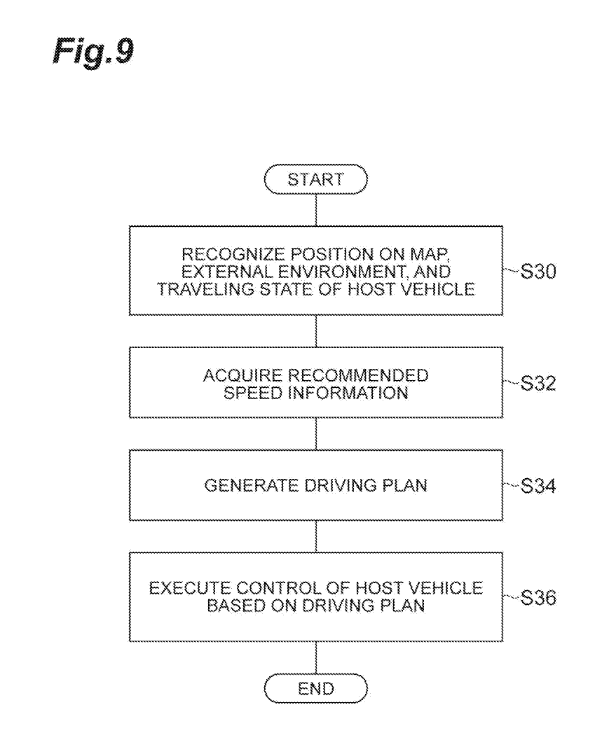

Next, processing of the vehicle control system according to the third embodiment will be described with reference to FIG. 9. FIG. 9 is a flow chart illustrating processing of the vehicle control system 300 according to the third embodiment. The flow chart illustrated of FIG. 9 is executed in a case where the driver's automatic driving starting operation is performed. Meanwhile, the flow chart illustrated of FIG. 9 may be executed in a case where conditions for starting automatic engagement are satisfied when the automatic engagement for starting automatic driving control based on determination on the system side is set.

As illustrated of FIG. 9, the ECU 30 of the vehicle control system 300 recognizes the position of the vehicle on the map by the vehicle position recognition unit 41 in S30. In S30, the ECU 30 recognizes an external environment of the vehicle by the external environment recognition unit 42 and recognizes a traveling state of the vehicle by the traveling state recognition unit 43.

In S32, the ECU 30 acquires recommended speed information by the recommended speed acquisition unit 44. The recommended speed acquisition unit 44 communicates with the road link information updating device 100 through the communication unit 36 to acquire the recommended speed information.

In S34, the ECU 30 generates a driving plan by the driving plan generation unit 45. The driving plan generation unit 45 generates a driving plan for the control of the vehicle, on the basis of a destination which is set in advance, the map information, the position of the vehicle on the map, the external environment of the vehicle, the traveling state of the vehicle, and the recommended speed information. The driving plan generation unit 45 generates the driving plan (vehicle speed plan) such that a vehicle speed of the vehicle passing through a node is set to be a recommended speed which is set in the node.

In S36, the ECU 30 executes the control of the vehicle based on the driving plan by the vehicle control unit 46. The vehicle control unit 46 executes the control of the vehicle such as automatic driving control, on the basis of the map information, the position of the vehicle on the map, the external environment of the vehicle, the traveling state of the vehicle, and the driving plan.

### Operational Effects of Vehicle Control System According to Third Embodiment

According to the above-described vehicle control system 300 of the third embodiment, a driving plan can be generated in consideration of a recommended speed which is set in a node by the road link information updating device 100, and thus it is possible to appropriately reflect the recommended speed which is set in the node for the control of traveling of the vehicle.

### Fourth Embodiment

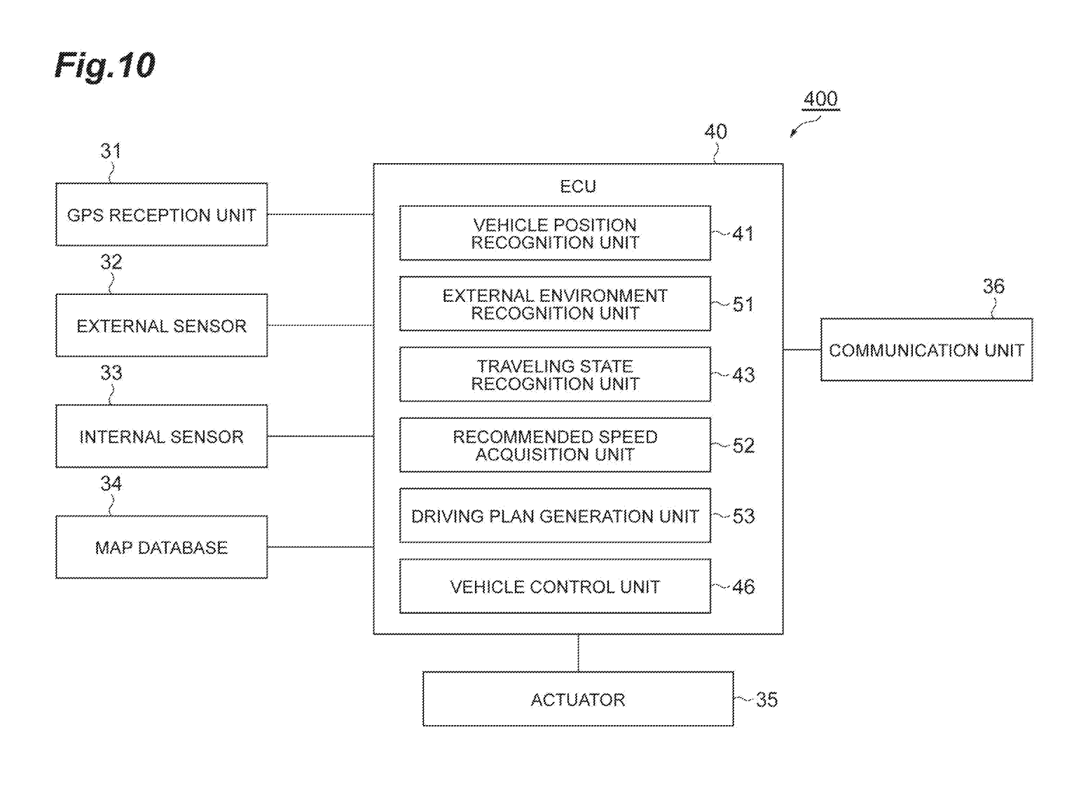

FIG. 10 is a block diagram of a vehicle control system according to a fourth embodiment. A vehicle control system 400 according to the fourth embodiment illustrated of FIG. 10 is different from the vehicle control system according to the third embodiment in that the setting of a recommended speed considering an external environment is reflected on the control of a vehicle. That is, the vehicle control system 400 uses a recommended speed for each classification of an external environment, which is set by the road link information updating device 200 according to the second embodiment, for the control of the vehicle.

### Configuration of Vehicle Control System According to Fourth Embodiment

An ECU 40 of the vehicle control system 400 is different from the ECU according to the third embodiment in that functions of an external environment recognition unit 51, a recommended speed acquisition unit 52, and a driving plan generation unit 53 are different from those in the third embodiment. The same or equivalent components as those in the third embodiment will be denoted by the same reference numerals and signs, and repeated descriptions will be omitted.

The external environment recognition unit 51 recognizes an external environment of the vehicle on the basis of a detection result of an external sensor 32, and recognizes classification of an external environment of the vehicle from the external environment of the vehicle. The external environment includes at least one of an inter-vehicle distance between the vehicle and a preceding vehicle, the density of vehicles in the vicinity of the vehicle, the density of pedestrians in the vicinity of the vehicle, the speed of another vehicle in the vicinity of the vehicle, and a time factor.

For example, the external environment recognition unit 51 recognizes whether the classification of the external environment of the vehicle is “short inter-vehicle distance” or “long inter-vehicle distance” from the inter-vehicle distance between the vehicle and the preceding vehicle. The external environment recognition unit 51 may recognize whether the classification of the external environment of the vehicle is “low vehicle density”, “middle vehicle density”, or “high vehicle density” from the density of vehicles in the vicinity of the vehicle.

Meanwhile, the external environment recognition unit 51 may combine a plurality of classifications of external environments to perform recognition. For example, the external environment recognition unit 51 may recognize whether the classification of the external environment of the vehicle is “long inter-vehicle distance” and “high vehicle density”.

The recommended speed acquisition unit 52 communicates with the road link information updating device 200 through a communication unit 36 to acquire recommended speed information on a recommended speed which is set in a node for each classification of an external environment by the road link information updating device 200. The recommended speed information includes positional information on the node and information on the recommended speed which is set for each classification of an external environment in the node.

The driving plan generation unit 53 generates a driving plan for the control of the vehicle, on the basis of a destination which is set in advance, map information of a map database 34, the position of the vehicle on the map which is recognized by a vehicle position recognition unit 41, the external environment of the vehicle and the classification of the external environment of the vehicle which is recognized by the external environment recognition unit 51, a traveling state of the vehicle which is recognized by a traveling state recognition unit 43, and the recommended speed information acquired by the recommended speed acquisition unit 52.

The driving plan generation unit 53 generates the driving plan (vehicle speed plan) such that a vehicle speed of the vehicle passing through a node is set to be a recommended speed which is set in response to classification of an external environment of the vehicle in the node, on the basis of the classification of the external environment of the vehicle which is recognized by the external environment recognition unit 51 and the recommended speed information acquired by the recommended speed acquisition unit 52. Specifically, the driving plan generation unit 53 generates the driving plan such that the vehicle speed of the vehicle passing through the node is set to be a recommended speed which is set in response to “short inter-vehicle distance” in the node, in a case where the classification of the external environment of the vehicle is “short inter-vehicle distance”.

Meanwhile, the driving plan generation unit 53 may generate the driving plan such that the vehicle speed of the vehicle passing through the node is set to be a recommended speed which is set in response to “long inter-vehicle distance” and “high vehicle density” in the node, when the recommended speed information includes information on a recommended speed in a case of “long inter-vehicle distance” and “high vehicle density” and the classification of the external environment of the vehicle is “long inter-vehicle distance” and “high vehicle density”.

### Vehicle Control System According to Fourth Embodiment

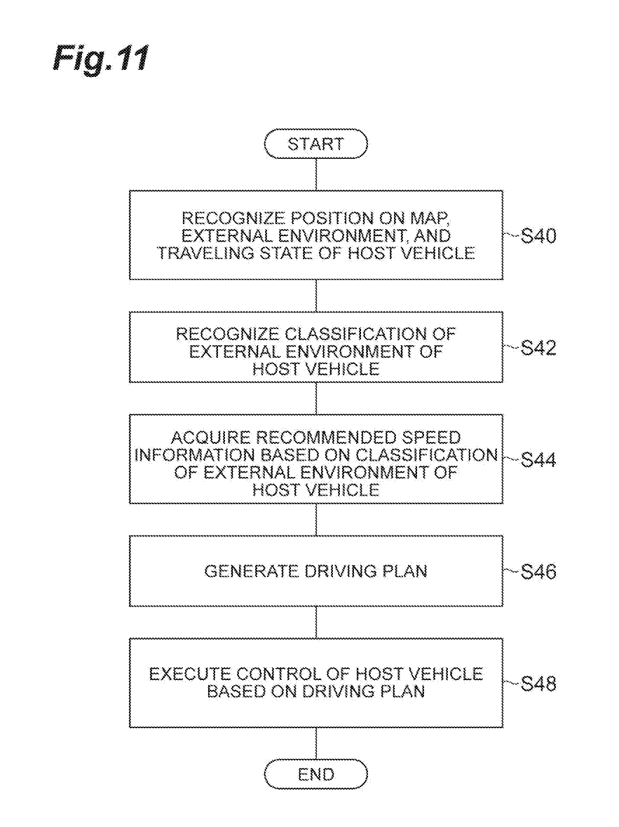

Next, processing of the vehicle control system according to the fourth embodiment will be described with reference to FIG. 11. FIG. 11 is a flow chart illustrating processing of the vehicle control system 400 according to the fourth embodiment. The flow chart illustrated of FIG. 11 is executed in a case where a driver's automatic driving starting operation is performed. Meanwhile, the flow chart illustrated of FIG. 11 may be executed in a case where conditions for starting automatic engagement are satisfied when the automatic engagement for starting automatic driving control based on determination on the system side is set.

As illustrated of FIG. 11, the ECU 40 of the vehicle control system 400 recognizes the position of the vehicle on the map by the vehicle position recognition unit 41 in S40. In S40, the ECU 40 recognizes an external environment of the vehicle by the external environment recognition unit 51 and recognizes a traveling state of the vehicle by the traveling state recognition unit 43.

In S42, the ECU 40 recognizes classification of an external environment of the vehicle by the external environment recognition unit 51. The external environment recognition unit 51 recognizes the classification of the external environment of the vehicle from the external environment of the vehicle which is recognized on the basis of a detection result of the external sensor 32.

In S44, the ECU 40 acquires recommended speed information by the recommended speed acquisition unit 52. The recommended speed acquisition unit 52 communicates with the road link information updating device 200 through the communication unit 36 to acquire recommended speed information considering the classification of the external environment.

In S46, the ECU 40 generates a driving plan by the driving plan generation unit 53. The driving plan generation unit 53 generates the driving plan (vehicle speed plan) such that a vehicle speed of the vehicle passing through a node is set to be a recommended speed which is set in response to classification of an external environment of the vehicle in the node, on the basis of the classification of the external environment of the vehicle which is recognized by the external environment recognition unit 51 and the recommended speed information acquired by the recommended speed acquisition unit 52.

In S48, the ECU 40 executes the control of the vehicle based on the driving plan by a vehicle control unit 46. The vehicle control unit 46 executes the control of the vehicle such as automatic driving control, on the basis of the map information, the position of the vehicle on the map, the external environment of the vehicle, the traveling state of the vehicle, and the driving plan.

### Operational Effects of Vehicle Control System According to Fourth Embodiment

According to the above-described vehicle control system 400 of the fourth embodiment, the driving plan of the vehicle can be generated so as to set a recommended speed based on classification of an external environment of the vehicle by using a recommended speed which is set in a corresponding node for each classification of an external environment by the road link information updating device 200, and thus it is possible to reflect an appropriate recommended speed based on the classification of the external environment of the vehicle on the control of traveling of the vehicle. Thereby, according to the vehicle control system 400, it is possible to prevent the control of the vehicle from giving uncomfortable feeling to a driver, as compared to a case where a recommended speed which is set in a node is reflected on the control of the vehicle without considering an external environment of the vehicle.

Although preferred embodiments of the invention have been described above, the invention is not limited to the above-described embodiments. The invention can be implemented in various modes subjected to various modifications and improvements based on the knowledge of those skilled in the art, including the above-described embodiments.

For example, the road link information updating devices 100 and 200 do not need to be fixedly installed in an institution, and may be mounted on a moving object such as a vehicle. The road link information updating servers 1 and 21 may be partially or entirely mounted on the moving object, or may be constituted by electronic units at a plurality of locations connected to each other through a network.

In the second embodiment, the inflection point position recognition unit 12 may recognize an inflection point position in consideration of classification of an external environment. Specifically, even when the width of a road in the road link is reduced during congestion, the reduction is hardly shown as a change in a vehicle speed of a communication target vehicle, and thus the inflection point position recognition unit 12 may use speed information in a case where the classification of the external environment is “low vehicle density”, for the recognition of the inflection point position. In a case where an inter-vehicle distance to a preceding vehicle is short, a change in a vehicle speed of the communication target vehicle may result from the movement of the preceding vehicle rather than from a geographic factor, and thus the inflection point position recognition unit 12 may use speed information in a case where the classification of the external environment is “long inter-vehicle distance”, for the recognition of the inflection point position. The inflection point position recognition unit 12 may use speed information in a case where the classification of the external environment is “long inter-vehicle distance” and “low vehicle density”, for the recognition of the inflection point position.

In addition, the vehicle control systems 300 and 400 in the third and fourth embodiments may transmit speed information including a vehicle speed or an acceleration of a vehicle to the road link information updating devices 100 and 200 in association with positional information of the vehicle. That is, the vehicle mounted with the vehicle control system 300 or 400 may be a communication target vehicle.

What is claimed is:

1. A road link information updating device comprising:
an information acquisition unit configured to acquire speed information on vehicle speeds or accelerations of communication target vehicles in association with positions of the communication target vehicles by communicating with the communication target vehicles;
a road link information database configured to store road link information on a plurality of nodes including a junction and a road link connecting the nodes to each other;
an inflection point position recognition unit configured to recognize an inflection point position in the road link from a change in the vehicle speed or the acceleration, on the basis of the speed information and the road link information;
a road link information updating unit configured to update the road link information by using the inflection point position as the node; and
a recommended speed setting unit configured to set a recommended speed in the node, on the basis of the speed information and the road link information.

2. The road link information updating device according to claim 1,
wherein the information acquisition unit acquires external environment information on the communication target vehicle and recognize the speed information for each classification of an external environment which is set in advance, by communicating with the communication target vehicle, and
wherein the recommended speed setting unit sets the recommended speed in the node for each classification of the external environment, on the basis of the speed information which is recognized for each classification of the external environment.

3. A vehicle control system comprising:
a recommended speed acquisition unit configured to acquire recommended speed information on a recommended speed of a node which is set in the road link information updating device according to claim 1;
a vehicle position recognition unit configured to recognize a position of the vehicle on a map;
an external environment recognition unit configured to recognize an external environment of the vehicle;
a traveling state recognition unit configured to recognize a traveling state of the vehicle;
a driving plan generation unit configured to generate a driving plan of the vehicle, on the basis of the recommended speed information, the position of the vehicle on the map, the external environment of the vehicle, and the traveling state of the vehicle; and
a vehicle control unit configured to control traveling of the vehicle in accordance with the driving plan.

4. A vehicle control system comprising:
a recommended speed acquisition unit configured to acquire recommended speed information on a recommended speed of a node for each classification of the external environment which is set in the road link information updating device according to claim 2;
a vehicle position recognition unit configured to recognize a position of the vehicle on a map;
an external environment recognition unit configured to recognize an external environment of the vehicle and classification of the external environment of the vehicle from the external environment of the vehicle;
a traveling state recognition unit configured to recognize a traveling state of the vehicle;
a driving plan generation unit configured to generate a driving plan of the vehicle, on the basis of the recommended speed information, the position of the vehicle on the map, the external environment of the vehicle, and the traveling state of the vehicle; and
a vehicle control unit configured to control traveling of the vehicle in accordance with the driving plan,
wherein the driving plan generation unit generates the driving plan by using the recommended speed based on the classification of the external environment of the vehicle in the road link based on the position of the vehicle on the map.
